(19) United States
(12) Patent Application Publication
(10) Pub. No.: US 2025/0020244 A1
(43) Pub. Date: Jan. 16, 2025

(54) SYSTEM FOR FIXING AN ELEMENT AND AIRCRAFT COMPRISING AT LEAST ONE SUCH SYSTEM

(71) Applicant: Airbus Operations SAS, TOULOUSE (FR)

(72) Inventors: Gérard MILLET, TOULOUSE (FR); Thierry LOPEZ, TOULOUSE (FR)

(21) Appl. No.: 18/769,028

(22) Filed: Jul. 10, 2024

(30) Foreign Application Priority Data
Jul. 12, 2023 (FR) 2307461

(51) Int. Cl. F16L 3/233; B65D 63/10

(52) U.S. Cl. CPC F16L 3/233; B65D 63/1027

(57) ABSTRACT

A support for a system for fixing an element comprising a hose clamp having a flexible link and a cage, the support comprising: a base comprising a recess in which the cage is housed and a first channel into which the link is fitted; an inclined upright extending from the base by moving away from the recess such that a free end of the upright is disposed at a distance from and facing an aperture which emerges in the recess. The link is able to penetrate into the first channel, surround the element, then penetrate in succession into the aperture of the recess and into the cage.

### CROSS-REFERENCES TO RELATED APPLICATIONS

This application claims the benefit of French Patent Application Number 2307461 filed on Jul. 12, 2023, the entire disclosure of which is incorporated herein by way of reference.

### FIELD OF THE INVENTION

The present invention relates to a support for a fixing system that makes it possible to fix an element. The invention relates more particularly to the fixing of an element in the form of one or more cables or ducts.

### BACKGROUND OF THE INVENTION

In an aircraft, it is often the case that cables or ducts have to be fixed to one another, to keep them together and to guide them in the aircraft in the form of an assembly called a harness.

Currently, to ensure such a fixing of the cables to one another, it is known practice to use hose clamps which conventionally comprise a flexible link and a cage secured to a first end of the link. The cage comprises a tunnel for receiving a second end of the link and is equipped with a blocking system allowing the displacement of the link in the tunnel in a single direction.

One drawback with this solution lies in the fact that, depending on the dimensions of the elements to be fixed to one another and/or depending on the materials in which they are manufactured, there is a risk of these elements being damaged by the hose clamp. Indeed, at the point where the second end of the link penetrates into the cage of the hose clamp, an angle is created and causes pinchings and/or significant frictions on the elements to be fixed. Elements, and notably electric cables, are often damaged in the use of such hose clamps, which can lead to failures.

It is therefore necessary to find a simple solution which makes it possible to ensure a fixing that is reliable and that does not damage the elements to be fixed to one another.

### SUMMARY OF THE INVENTION

One object of the present invention is to propose a support for a fixing system which make it possible to fix an element simply and rapidly.

To this end, a support is proposed for a fixing system intended to fix an element, said fixing system comprising a hose clamp having a flexible link and a cage secured to a proximal end of the link and having a tunnel, said support comprising:
a base that is globally rectilinear between a first end and a second end, comprising, at the first end and on a first face of said base, a recess in which said cage of said hose clamp is intended to be housed, said base comprising an aperture which emerges in the housing, said aperture being intended to be disposed facing said tunnel of said hose clamp and allow the passage of a distal end of said link, and between the recess and the second end, a first guiding channel into which said link of said hose clamp is intended to be fitted, and
a support upright secured to the base at the second end and to a second face of said base opposite said first face of said base and extending from the second end by approaching the first end such that a free end of said upright is disposed at a distance from and globally facing the aperture.

Said distal end of said link is intended to penetrate into said first channel, surround said element, then penetrate in succession into the aperture of the base and into said tunnel of said cage.

The support of the invention therefore makes it possible to insert a bearing, or protection, surface between the element to be fixed and the link of the hose clamp at the point where the distal end of the link penetrates into the cage of the hose clamp, that is to say at the critical point where an angle is conventionally formed and where the risks of damaging the element are usually high. In this way, the element can be fixed simply while avoiding undesirable damage thereto.

Advantageously, said upright is curved, the center of curvature of said upright being situated opposite said base with respect to said upright.

According to a particular aspect of the invention, said upright is elastic and said base comprises a portion extending between said first channel and said second end which is also elastic.

According to another particular aspect of the invention, said recess comprises at least one rod intended to hold said cage, each rod extending globally at right angles to said base, a free end of each rod comprising a tooth protruding globally parallel to said first face towards the second end. Said cage of said hose clamp is intended to be held in said recess by contact with the base, said at least one rod and said at least one tooth.

According to a particular aspect of the invention, said base comprises, at the second end, a first means intended to guide said link.

According to another particular aspect of the invention, said upright comprises, at its free end, a second means intended to guide said link.

According to yet another particular aspect of the invention, one or each means intended to guide said link takes the form of a fork with two teeth and the link is intended to be guided between the two teeth.

According to a particular aspect of the invention, said upright comprises, at its free end, a second channel intended to guide said link.

The invention relates also to a fixing system intended to fix an element, said system comprising:
a hose clamp having a flexible link and a cage secured to a proximal end of the link and having a tunnel for receiving a distal end of the link, in which the cage is equipped with a blocking system allowing the displacement of the link in the tunnel in a single direction; and
a support as described previously.

The invention further relates to an aircraft comprising at least one element to be fixed and at least one system for fixing said at least one element as described previously.

### BRIEF DESCRIPTION OF THE DRAWINGS

The features of the invention mentioned above, and others, will emerge more clearly on reading the following description of an exemplary embodiment, said description being given in relation to the attached drawings, in which:

FIG. 1 illustrates a perspective view of a fixing system according to an exemplary embodiment of the invention;

FIG. 2 illustrates another perspective view of the fixing system of FIG. 1;

FIG. 3 is a perspective view illustrating a support according to the invention which is implemented in the fixing system of FIG. 1;

FIG. 4 illustrates a perspective view of a variant of the fixing system of FIG. 1; and

FIG. 5 illustrates an aircraft comprising a plurality of fixing supports according to the invention.

### DETAILED DESCRIPTION OF THE PREFERRED EMBODIMENTS

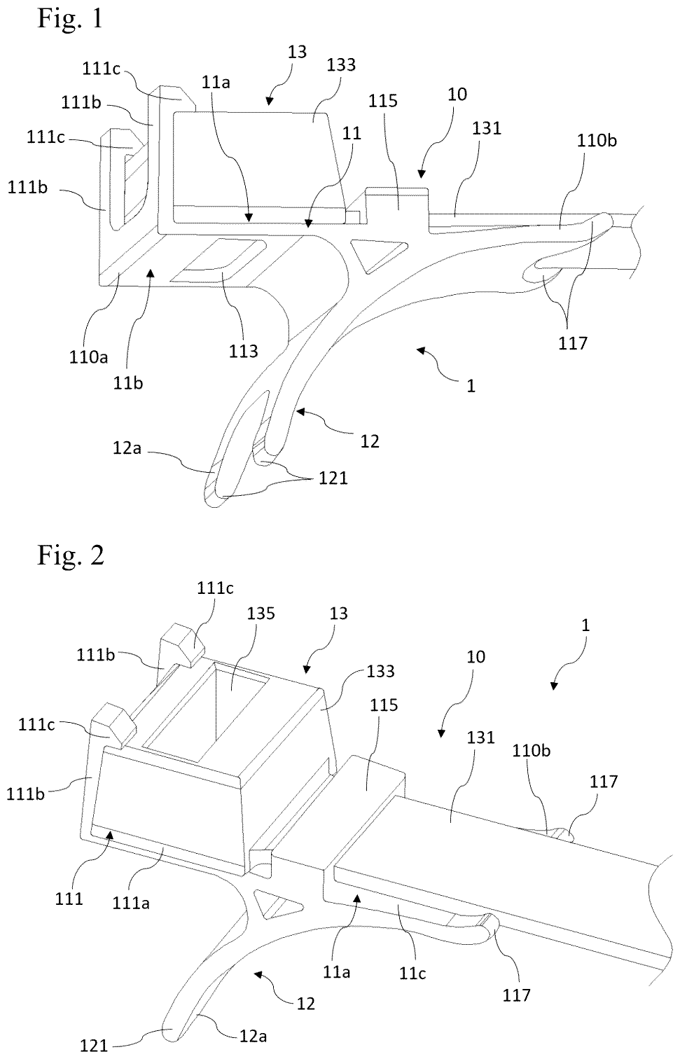

FIG. 1 shows a fixing system 1 which is hereinafter called “system”. The system 1 makes it possible to fix an element 9 which can take different forms. The element 9 can be composed of one or more cables 91 (as illustrated in FIG. 4) or ducts, or any other element to be fixed.

The system 1 comprises a hose clamp 13 and a support 10 according to the invention.

The hose clamp 13 is produced for example in plastic. It takes, for example, the form of a cable tie known by the name Ty-Rap®.

The hose clamp 13 comprises a flexible link 131 and a cage 133 secured to a proximal end of the link 131. The cage 133 is passed through by a tunnel 135 into which the distal end of the link 131 is inserted.

The cage 133 is equipped with a blocking system allowing the displacement of the link 131 in the tunnel 135 in a single direction, called clamping direction, and preventing the displacement of the link 131 in the tunnel in a direction opposite to the clamping direction.

According to a particular embodiment, the blocking system comprises a ratchet system which is housed in the tunnel 135 and teeth produced on one of the faces of the link 131. The teeth interact with the ratchet system to allow the displacement of the link 131 in the tunnel 135 in the clamping direction and prohibit the displacement of the link 131 in the opposite direction.

According to a particular embodiment, the blocking system can be releasable to release the link 131 in order to extract it from the tunnel 135.

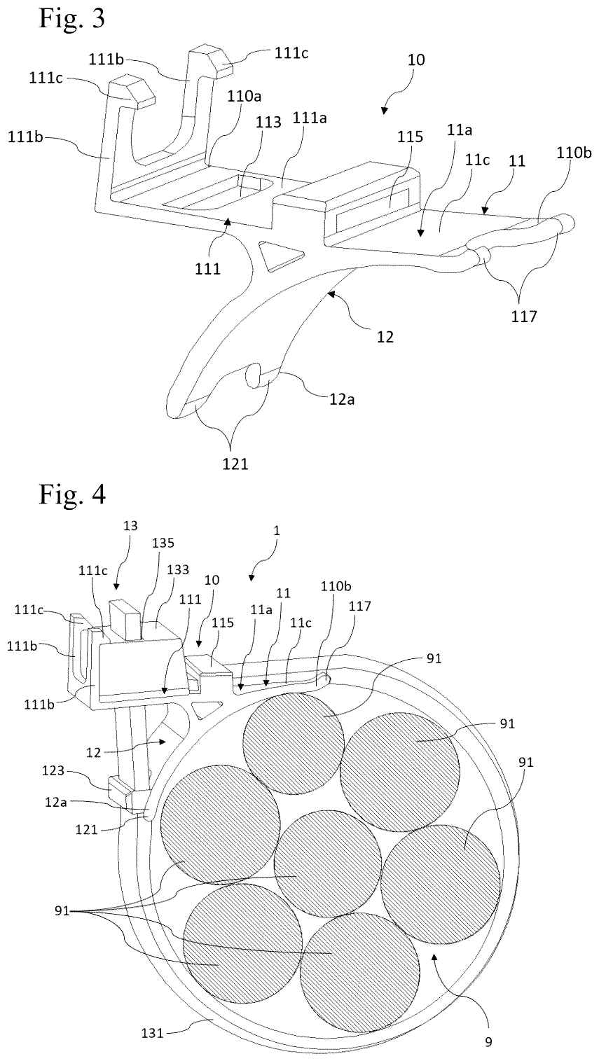

The support 10 according to the invention, of which a first embodiment is represented in isolation in FIG. 3, has a base 11 that is globally rectilinear between a first end 110a and a second end 110b. The base 11 comprises, at the first end 110a and on a first face 11a (that is to say the top face according to the orientation of the support 10 in FIGS. 1 to 3), a recess 111 in which the cage 133 of the hose clamp 13 is intended to be housed.

The base 11 comprises a through-aperture 113 which emerges in the recess 111 and facing the tunnel 135 of the cage 133 when the hose clamp 13 is housed in the recess 111. The aperture 113 is intended to allow the passage of the distal end of the link 131 of the hose clamp 13.

The base 11 comprises, in the extension of the recess 111 and opposite the first end 110a, that is to say between the recess 111 and the second end 110b, a first guiding and holding channel 115 into which the link 131 of the hose clamp 13 is intended to be fitted. The first channel 115 is intended to ensure an optimal positioning and holding of the link 131 with respect to the support 10. In addition, the first channel 115 being disposed in proximity to the recess 111, the first channel 115 contributes also to the good holding of the cage 133 when the hose clamp 13 is housed in the recess 111. The first channel 115 is therefore intended to avoid the separation of the hose clamp 13 and of the support 10.

The support 10 further comprises a support upright 12 secured to the base 11 at the second end 110b, and a second face 11b opposite the first face 11a of the base 11 (that is to say the bottom face according to the orientation of the support 10 in FIGS. 1 to 3). More particularly, the upright 12 extends from the second end 110b of the base 11 by moving away from the base 11 and by approaching the first end 110a such that the free end 12a of the upright 12, that is to say the end opposite the base 11, is disposed at a distance from and globally facing the aperture 113. In other words, the upright 12 extends in an inclined manner with respect to the base 11, here below the base 11 according to the orientation of the support 10 in FIGS. 1 to 3.

To fix the element 9, the cage 133 of the hose clamp 13 is intended to be housed and held in the recess 111 of the base 11. The distal end of the link 131 is intended to penetrate into the first channel 115 and surround the element 9. Finally, the distal end of the link 131 is intended to penetrate in succession into the aperture 113 of the base 11 and into the tunnel 135 of the cage 133. The blocking means of the hose clamp 13 make it possible to immobilize the link 131 and ensure the fixing of the assembly.

The upright 12 is therefore intended to constitute a bearing, or protection, surface disposed between the element 9 and the link 131 of the hose clamp 13 at the point where the distal end of the link 131 penetrates into the cage 133 of the hose clamp 13, that is to say at the critical point where an angle is conventionally formed and where the risks of damaging the element 9 are usually high. In this way, the risks of pinching and friction of the hose clamp 13 on the element 9 at this critical point are avoided. The invention therefore makes it possible to simply fix the element 9 with a hose clamp 13 while avoiding undesirable damage thereto.

Preferentially, and as illustrated in this example, the upright 12 is curved to adapt best to the element 9 to be fixed, which here has a section of globally circular form. The center of curvature of the upright 12 is situated opposite the base 11 with respect to the upright 12.

The upright 12 is preferably elastic, such as a leaf spring. In this way, the portion 11c of the base 11 extending between the first channel 115 and the second end 110b of the base 11 is elastic. The fact that the upright 12 and the portion 11c are elastic makes it possible to even better adapt the support 10 to the variable forms and dimensions of the elements 9 to be fixed.

In addition, this elasticity of the upright 12 and of the portion 11c of the base 11 also makes it possible to provide a soft curvature, that is to say a progressive curvature, to the support 10 so as to avoid the risks of pinching and friction of the support 10 and of the hose clamp 13 against the element 9 to be fixed.

In the embodiment of the invention presented in FIGS. 1 to 3, the recess 111 comprises at least one rod 111b intended to hold the cage 133 in the indentation 111a. In this example, the recess 111 comprises two rods 111b disposed parallel to and globally in the corners of the base 11 at the first end 110a.

The rods 111b extend globally at right angles to the base 11 from the first face 11a. In other words, the rods 111b extend upwards according to the orientation of the support in FIGS. 1 to 3.

The free end of the rod 111b, that is to say the end opposite the base 11, comprises a tooth 111c protruding globally parallel to the first face 11a of the base 11 and towards the second end 110b.

In this way, the cage 133 of the hose clamp 13 is intended to be held in the recess 111 by contact, that is to say by engagement, with the base 11, the rods 111b and the teeth 111c. Thus, the hose clamp 13 can be held secured to the support 10 even in the case of breakage of the link 131. In addition, the recess 111 makes it possible to avoid any undesirable displacement of the hose clamp 13 with respect to the support 10.

In a variant that is not illustrated, it would be possible to envisage disposing the first channel 115 at a distance from the first end 110a corresponding to the dimensions of the cage 133 so as to add an additional point of contact and further improve the holding of the cage 133 of the hose clamp 13 in the recess 111.

In the embodiment of the invention presented in FIGS. 1 to 3, the base 11 comprises, at the second end 110b, a first means 117 intended to guide the link 131. Similarly, the upright 12 comprises, at its free end 12a, a second means 121 intended to guide the link 131.

The guiding means 117 and 121 are intended to ensure an optimal centering and optimal positioning of the link 131 of the hose clamp 13 on the support 10 and on the element 9. Thus, the risks of pinching, of friction and therefore of damage to the element 9 are avoided.

For example, the first 117 and/or the second 121 guiding means take the form of a fork with two teeth between which the link 131 is intended to be inserted and guided.

In a variant embodiment illustrated in FIG. 4, the upright 12 further comprises, at its free end 12a and in proximity to the second fork 121, a second channel 123 intended to guide and hold the link 131. The second channel 123 makes it possible to ensure an optimal positioning and optimal holding of the link 131 with respect to the support 10.

Furthermore, the implementation of the first 115 and second 123 channels makes it possible to prevent the separation of the hose clamp 13 and of the support 10 in the event of unexpected breakage of the link 131. Such an implementation is intended to avoid the loss of one of the elements of the system 1, and that remains so regardless of the point of the breakage of the link 131 (for example between the cage 133 and the first channel 115, between the first 115 and second 123 channels, or between the second channel 123 and the cage 133, in particular).

Such a support 10 makes it possible to provide a simple and inexpensive solution for fixing an element 9. In addition, the support 10 makes it possible to use hose clamps 13 that are known and commonly used, while overcoming any risks of damage to the element 9 by this type of hose clamp.

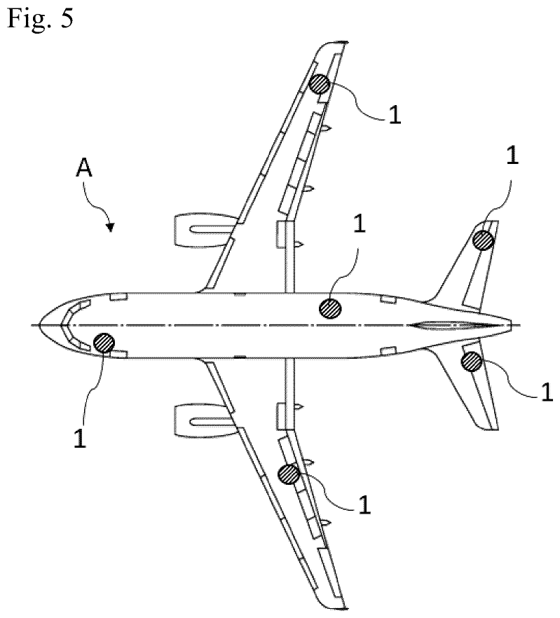

FIG. 5 represents an aircraft A comprising at least one system 1 for fixing an element 9. The use of such fixing systems 1 in an aircraft advantageously makes it possible to facilitate the operations of mounting the electrical, electronic or fluidic systems, notably in cramped places, and thus increase productivity. Advantageously, the fixing system 1 can be shipped in the form of a kit comprising a support 10 on which the cage 133 of the hose clamp 13 is already housed in the recess 111 of the support 10.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A support for a fixing system configured to fix an element, said fixing system comprising a hose clamp having a flexible link and a cage secured to a proximal end of the link and having a tunnel, said support comprising:
a base globally rectilinear between a first end and a second end and comprising, at the first end and on a first face of said base, a recess in which said cage of said hose clamp is configured to be housed, said base comprising an aperture which emerges in the recess, said aperture configured to be disposed facing said tunnel of said hose clamp and allow passage of a distal end of said link, and between the recess and the second end, a first guiding channel into which said link of said hose clamp is configured to be fitted, and
a support upright secured to the base at the second end and to a second face of said base opposite said first face of said base and extending from the second end by moving away from the base and by approaching the first end such that a free end of said support upright is disposed at a distance from and globally facing the aperture;
wherein said distal end of said link is configured to penetrate into said first channel, surround said element, then penetrate in succession into the aperture of the base and into said tunnel of said cage.

2. The support according to claim 1, wherein said support upright is curved, and
wherein a center of curvature of said support upright is situated opposite said base with respect to said support upright.

3. The support according to claim 1, wherein said support upright is elastic, and
wherein said base comprises a portion extending between said first channel and said second end which is elastic.

4. The support according to claim 1, wherein said recess comprises at least one rod configured to hold said cage, each rod extending globally at a right angle to said base, a free end of each rod comprising a tooth protruding globally parallel to said first face towards the second end,
wherein said cage of said hose clamp is configured to be held in said recess by contact with the base, with said at least one rod, and with said tooth.

5. The support according to claim 1, wherein said base comprises, at the second end, a first means configured to guide said link.

6. The support according to claim 1, wherein said support upright comprises, at the free end, a second means configured to guide said link.

7. The support according to claim 5, wherein said first means comprises a fork with two teeth, and
wherein the link is configured to be guided between the two teeth.

8. The support according to claim 6, wherein said second means comprises a fork with two teeth, and
wherein the link is configured to be guided between the two teeth.

9. The support according to claim 1, wherein said support upright comprises, at the free end, a second channel configured to guide said link.

10. A fixing system configured to fix an element, said fixing system comprising:
a hose clamp comprising a flexible link and a cage secured to a proximal end of the flexible link and having a tunnel for receiving a distal end of the flexible link, wherein the cage comprises a blocking system configured to allow a displacement of the flexible link in the tunnel in a single direction; and
the support according to claim 1.

11. An aircraft comprising:
at least one element to be fixed and
at least one fixing system according to claim 10.
